(19) United States
(12) Patent Application Publication
(10) Pub. No.: US 2009/0077825 A1
(43) Pub. Date: Mar. 26, 2009

(54) APPARATUS AND METHOD FOR CLEANING AND DRYING SOLID OBJECTS

(75) Inventors: Jahansooz Toofan, Sacramento, CA (US); Mahmood Toofan, Gilroy, CA (US)

Correspondence Address: Mahmood Toofan;SAS Inc., 1765 Landess Avenue #20, Milpitas, CA, 95035, US

(73) Assignee: Semiconductor Analytical Services, Inc. (SAS Inc.), Milpitas, CA (US)

(21) Appl. No.: 12/173,464

(22) Filed: Jul. 15, 2008

Related U.S. Application Data
(60) Provisional application No. 60/961,360, filed on Jul. 17, 2007.

(51) Int. Cl. F26B 3/28; F26B 5/04; F26B 11/00

(52) U.S. Cl. 34/273; 34/259; 34/358; 34/409; 34/412; 34/420; 34/60; 34/181

(57) ABSTRACT

An apparatus and a method are described to dry solid objects being manufactured in a chain of steps. The apparatus contains a cartridge to hold the objects, a chamber to house the cartridge, nozzle sections to spray drying agents on the objects, and a vacuum section to remove the drying agent and the released solvent. The apparatus also contains an optical radiation source such as an IR lamp for heating the objects, which can be used in conjunction with the vacuum section for removing solvent and drying steps. The cartridge or the nozzles can be swayed changing the orientation of the objects and the nozzles. The spraying step and evacuating steps can be repeated as needed.

This application claims priority to U.S. Provisional Patent application No. 60/961,360 filed on Jul. 17, 2007.

### TECHNICAL FIELD

This invention relates to a method and apparatus for cleaning and drying substantially flat solid objects. The solid objects suitable to be cleaned and dried by this invention are semiconductor substrates, wafers, photo-masks, disks, substrates, ceramic plates, optical devices, and MEMS devices. The apparatus and method are usable as part of a chain of steps in manufacturing semiconductor wafers, magnetic discs, or any other printed circuit manufacturing processes.

### BACKGROUND

In the course of manufacturing semiconductor devices, or similar flat media such as CD glass, photo-masks, flat panel displays, hard disk media, etc., by the wet processing approach, semiconductor devices are washed with solvents, rinsed, and dried before moving to the next step in the process. Any rinsing solvent that remains on the surface of a semiconductor wafer has the potential for depositing contaminants that may cause defects in the end product. In practice, de-ionized (DI) water is used most frequently as the rinsing fluid. Like most other fluids after rinsing DI water will cling to wafer surfaces in sheets or droplets, due to the surface tension. This left behind water, or solvent, needs to be removed to render the wafer dry. Other factors to consider are time and cost of this drying process. Also, the whole process should take place inside the clean room.

The rinsing step often leaves a thin film or droplets of water, on the wafer surface. The rinsing step is incremental by nature and is further complicated by the presence of a surface that can adsorb ions and other chemical compounds. As such rinsing has to be repeated several times to remove the surface adsorbed impurities. The wafers are then transferred to the dryer unit for removing the thin water (solvent) layer from the surface of the object.

Using heat to dry the wafers leads to water spots that are detrimental to the next manufacturing step. The U.S. Pat. No. 6,158,141 granted to Asada, et al describes an approach to replace the water film with isopropyl alcohol (IPA). The method replaces the water at the surface with IPA using a liquid bath and sprayed hot vapor using nozzles placed in the drying chamber. In this approach, the wafers are dipped into a bath of IPA and then removed slowly relying on the meniscus formed between the liquid and the solid to remove some or all water. The wafer is then moved into the upper part of the chamber where IPA vapor is sprayed into the chamber using nozzles that are designed to fill the entire volume of the chamber with vapor. At the end of this process, there is a reduced amount of IPA on the surface of the wafer, but the inventors consider these wafers dried and suggest the wafers with this residual IPA on their surface be moved to the next manufacturing step. In processes that use IPA in their next step, this may be possible, but in general IPA with a boiling point of 82.5 degree C. and its strong surface attraction caused by hydrogen bonding with sionol groups (Si—OH, on the surface) is far from being removed.

Other methods used in the art of drying semiconductor wafers include using centrifugal force for removing the water without replacing it with IPA. It is also suggested to first replace the water with IPA and then use the centrifugal force to remove the residual IPA. These devices are essentially centrifuges that spin the wafers at high enough rpm to expel the adsorbed liquid from the surface and dry the wafer. This technique relies on strong mechanical forces and is suitable for thicker substrates that can survive such forces.

With the advancements in the technology, the wafers have become thinner and more frangible, and the features have been miniaturized to sub-micron levels. The newer wafers are too thin to withstand the centrifugal force needed to remove IPA. In addition, the new technology has placed more stringent limits on the size and number of residues, such as water spots, such that the old drying techniques are not satisfactory anymore. Similar drying technology applies to the manufacturing of magnetic discs and other devices listed above. Therefore there is a need for an instrument and method that cleans and dries the semiconductor wafers without the use of centrifugal force.

### SUMMARY

One aspect of the invention is a drying apparatus for use in a chain of manufacturing steps for drying an object having residual solvent on its surface. The apparatus contains a cartridge to hold the objects, a chamber to house the cartridge, nozzle sections to spray drying agents on the objects, and a vacuum section to remove the drying agent and the released residual solvent. The apparatus also contains an optical radiation source for heating the objects, which can be used in conjunction with the vacuum section during the removing step or at the final step for removing any drying agent from the surface of the objects.

In another aspect of the invention the cartridge in the drying apparatus is equipped to sway the objects relative to the spraying nozzles. The swaying between objects and nozzles may be performed with nozzle sections that are equipped to sway the nozzles in addition or instead of the cartridge.

Another aspect of the invention is a method to dry an object that is being manufactured in a chain of steps. The object having residual solvent on its surface and is placed in a drying apparatus, sprayed with drying agents to replace the solvent with the drying agent. The released solvent and excess drying agents are pumped out using a vacuum section and the objects may be heated using an optical radiation source while pumping. This step may be repeated as needed. The objects having drying agent on their surface are then dried using the heat and vacuum.

In another aspect of the method of drying the objects, the objects and/or the nozzles are swayed relative to each other during the spraying step.

### BRIEF DESCRIPTION OF THE DRAWING

FIG. 1 is a schematic drawing of an apparatus for drying solid objects in accordance with this invention.

FIG. 2 shows the part of the dryer that prepares hot gas and mixes it with a liquid drying agent.

FIG. 3 is a close up view of the spraying section of the dryer.

FIG. 4 is the detailed view of the spraying section showing the nozzles.

FIG. 5A is a view of the mechanism for swaying the launch boat and the cassette holder in the xy plane.

FIG. 5B is a view of the mechanism for swaying the cassette holder in the xy plane.

FIG. 5C is a view of the mechanism for swaying the cassette holder in the z direction.

FIG. 6 shows how the nozzles can be positioned above the surface of the object.

FIG. 7 shows a method of drying solid objects in accordance with this invention.

### DETAILED DESCRIPTION

The drying apparatus and method of this invention is designed to remove residual liquids (solvents) from the surface of solid objects. The solid objects include, but not limited to semiconductor substrates, wafers, photo-masks, magnetic disks, other disks, substrates, ceramic plates, optical devices, and MEMS devices. In the following section they may be referred to as objects, wafers, substrates. The liquids that are removed include water and water based solutions that have been used to rinse the solid objects, for example, in the manufacturing process.

In one embodiment, the apparatus of this invention comprises a process chamber that houses the solid objects and a drying agent delivery system. The process chamber includes one or more spray sections having multiple spray nozzles for applying the drying agents to the surfaces of the solid objects and to their immediate vicinity. The drying agent delivery may also include inlets for delivering a supply of gases or vapors to the inside space of the chamber. The chamber further includes heating devices, such as infra-red (IR) lamps, to heat the solid objects without introducing any contaminants.

In another embodiment, the drying agents comprise one or more chemical compounds, preferably a mixture, that help remove or replace the water and water based solutions, herein referred to as water, from the surface of the solid objects. In an embodiment of this invention, the drying agents are more than one chemical mixture and may be repeatedly applied and in more than one step. The first drying agent, for example, may be a stream of gas or hot water vapor that removes some, but not all, the water from the surfaces amounting to a partial drying step. The partial drying step may be followed by one or more drying steps in which other chemical mixtures are delivered to the process chamber and the solid objects are exposed to these other chemical mixture to replace the water from their surfaces. Once the water is removed from the surfaces or replaced, other methods such as heating, vacuum, or a combination thereof can be used to finish the drying step. In one embodiment of this invention, the heating is provided by IR radiation.

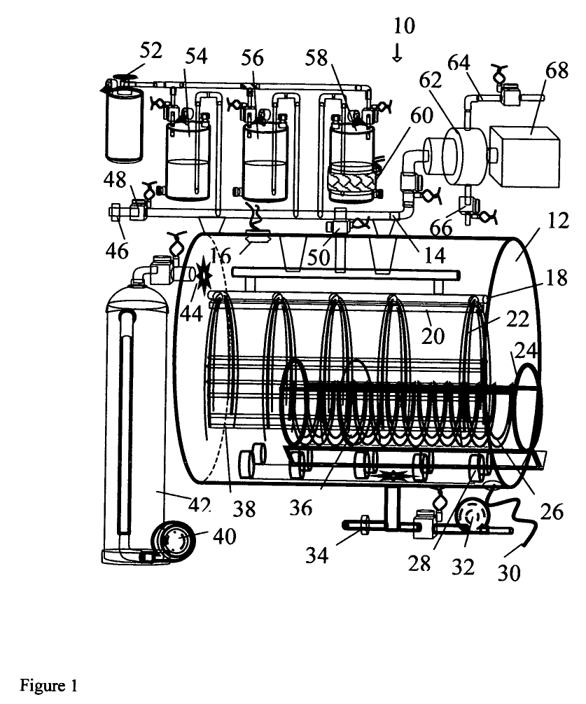

One embodiment of the invention is shown in FIG. 1. Apparatus 10 for drying the surfaces of solid objects 36 is schematically shown in FIG. 1. The drying apparatus 10 includes a process chamber 12, movable launch boat 24, and cassette holder 26 with provisions to house the solid objects 36. The cassette holder 26 is supported by the launch boat 24, which in turn is supported by launch boat support 28 resting in the chamber. The movable launch boat 24 is equipped with a swaying mechanism and can sway the objects in the cassette holder 26 (cartridge) to facilitate the drying process. The inside of the chamber and all components inside the chamber are preferably made of a non-corroding material such as stainless steel and it also may be covered with a thin film of polymer such as PTFE or any none reactive contamination free high dense polymer such as HDPP (high density poly propylene), HDPE (high density polyethylene) to prevent adherence of solvent and drying agents to their surfaces. Alternatively the cartridge 26 may be made of PTFE. In this embodiment, centrifugal force is not used for the drying process; as such the solid objects 36 and cartridge 26 are not rotated at high speed. This reduces the risk of breakage by centrifugal and other mechanical forces. Lack of strong mechanical motion also prevents wear and tear and more importantly the associated particulate generation that can interfere with proper drying. Although the dryer 10 is designed not to move or rotate the solid objects 36 and the cartridge 26 using high mechanical forces, an optional feature of the device is to have provisions to move and/or tilt (sway) the solid objects gently to facilitate the drying.

The cartridge 26 can be of a design that accommodates the size and number of solid objects 36 that are to be dried. The apparatus 10 and the launch boat 24 can be equipped with a variety of different cartridges 26 to facilitate using different solid objects in the same dryer. The dryer 10 can work as a stationary unit where it is installed in a convenient location within the manufacturing chain of steps for maximum yield. Since dryer 10 does not use strong mechanical motions, there is no need for elaborate installation on the manufacturing floor and in fact it can be made portable and rolled to the desired location with ease. The latter feature reduces the capital expenditure by allowing the dryer 10 to be shared by different manufacturing chain of steps.

The apparatus 10 also has mechanisms of delivering drying agents to the solid objects. The mechanism comprising for example, a career gas 52, DI water 54, cold solvent 56, heated solvent 58, and a heater 60 is for delivering substantially liquid agent and the mechanism comprising for example, a nitrogen gas heater 68, solvent feeder 64, solvent evaporator 62, solvent drain 66, and feeding pipe 14 is for delivering substantially gaseous drying agents. A feeder valve 50 along with other valves in the system can be programmed to choose which mechanism to be connected to the chamber 12 at each instant. A temperature/pressure sensor 16 is used to constantly monitor these parameters inside chamber 12.

The drying apparatus 10 includes an optical radiation source 20 to heat the objects and to vaporize the drying agents in order to remove them from the surface of the solid objects. The optical radiation source may be an infra-red (IR) lamp, a visible lamp, or a source of microwave radiation. Existing method of heat-drying the objects use hot gas to vaporize the liquid films adhered to the surface of the solid objects. Using IR lamps for heat-drying the solid objects, the dryer 10 is not limited to having a gas flow in the drying chamber, rather it is possible to heat-dry the solid objects with a flowing gas or in vacuum.

The apparatus 10 also includes a vacuum pump 40 to pump the vapors out of the process chamber 12. The line connecting the vacuum pump 40 and chamber 12 may contain an optional pre-vacuum tank 42. The tank 42 is constantly evacuated, even when the chamber is not being evacuated. As a result it enhances the efficiency of the vacuuming steps. The pump 40 is constantly evacuating this tank and whenever the chamber needs to be evacuated, a valve is actuated that draws the content of the chamber through vacuum port 44 through the tank 42 to vacuum pump 40. The vacuum path may also contain a condenser (not shown) to liquefy the vapors. The condenser prevents the liquefied drying agents from entering the vacuum pump and interfering with its operation. In addition, the liquefied drying agents can be purified and re-used in the drying process thereby reducing the waste and associated environmental effects.

In another embodiment, the drying agents such as gas, vapor, or liquid can be heated before entering the process chamber 12. This can be done by placing heating elements around the metal tubes that are used to deliver the gas to the process chamber 12, not shown. Alternatively, one can use heating coils 60 around the drying agent tank 58 to supply preheated drying agents. In a preferred embodiment, an IR lamp can be used to heat the drying agents, (not shown). IR radiation is readily adsorbed by common ceramic materials, thus the drying agents can be flown through a tube or a series of tubes that are made at least partly out of ceramic material or metal tubes that are covered with ceramic and the IR lamps are used to heat the ceramic parts that in turn transfer the thermal energy to the flowing drying agent.

A compressed gas tank 52 is provided that can be used as one of the drying agents, assist in delivering liquid drying agents, or by its flow help circulate the heated vapors out of the process chamber. The dryer 10 may also include one or more liquid supply tanks 54, 56, and 58 that contain the liquid drying agents. The compressed gas may be particle free nitrogen, air, inert gas such as argon, or a combination thereof. The compressed gas can serve as a drying agent in the first, partial drying, step by blowing away large droplets of water from the surface and the edges of the solid objects. The liquid drying agent is delivered to the vicinity of the solid objects by a supply line through valve 50. The drying agent passes through a distributor line 18, arch lines 22, and spray bars 38 to reach the spray nozzles residing in the spray bar. In the exemplary embodiment of FIG. 1, there are three spray bars on each side of the cassette 26.

The chamber 12 is also connected to a grounding strip 30 to prevent any electrostatic charge buildup. It is also connected to a liquid drain comprising a liquid condenser unit 32, and a liquid drain port 34.

The height of the assembly containing the spray bars 38 and IR lamp 20 can be adjusted to accommodate different size solid objects. This adjustment also enables the nozzles to be placed in an optimum position relative to the surface of the solid object. FIG. 1 shows three nozzle sections on each side of the object, but there may be more nozzles sections and the nozzles may be distributed at angles that range from −60 degree to +60 degree relative to the horizontal direction.

Using the hot organic solvent vapor as drying agent, it is important to have safety measures in place. The embodiment of FIG. 1 is provided with a temperature/pressure sensor 16 as well as provision to deal with any possible fire. The chamber 12 is equipped with an emergency automatic/manual CO₂ fire distinguisher that can be activated in relation to the temperature sensor (16).

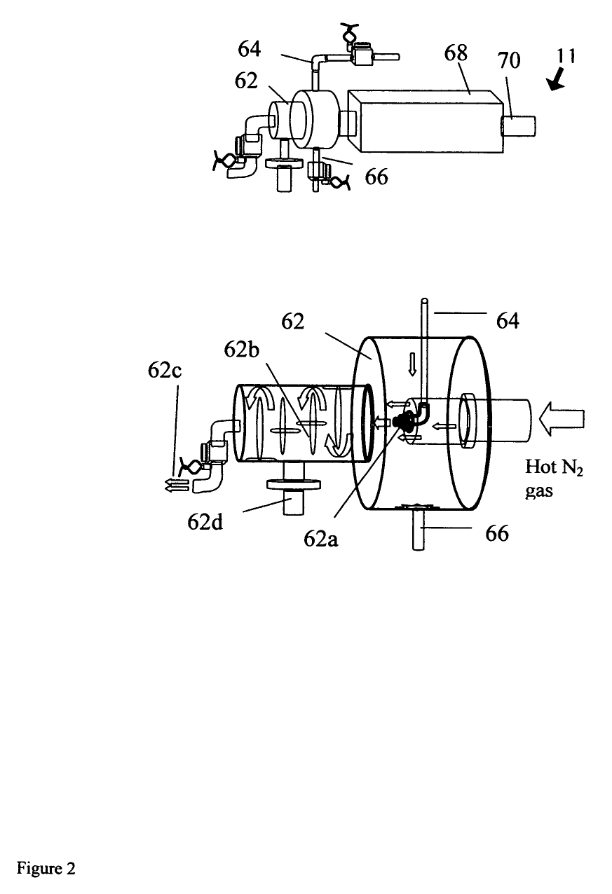

FIG. 2 shows more detailed part of FIG. 1 dealing with gaseous drying agent. As FIG. 2 shows, gas from a compressed gas supply is delivered through a pipe 70 to the gas heater 68 and is directed to a solvent evaporator 62. The solvent evaporator 62 receives the liquid drying agent from pipe 64, which passes through a nozzle 62a and generates a fog or mist of liquid drying agent suspended in the gas. The vaporized liquid and hot gas pass through a series of shields 62b that ensure proper mixing and allow controlling the mixture. A relief valve 62d provides operational safety and the mist exits through an outlet 62c to feeding chamber pipe 14. The fog or mist spray so formed is delivered to the spray nozzles and is sprayed on the solid objects to be dried. The vaporized liquid penetrates between the solid objects and in the fine features on the solid objects to thoroughly remove or replace water. This feature of the invention reduces the volume of the drying agent needed and has economical as well as environmental impact.

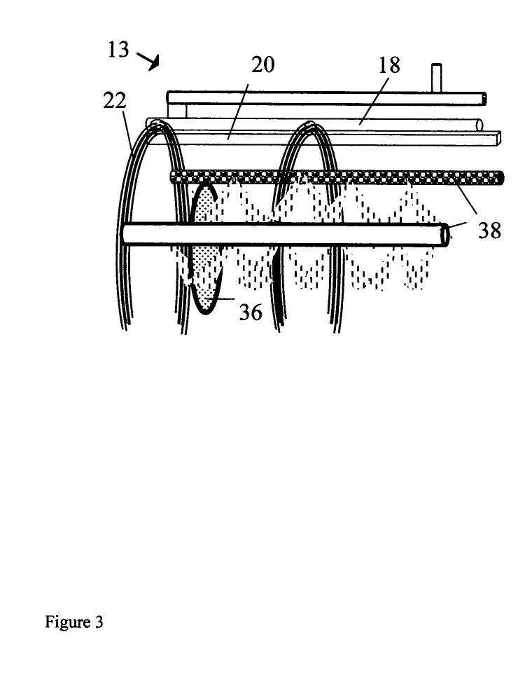

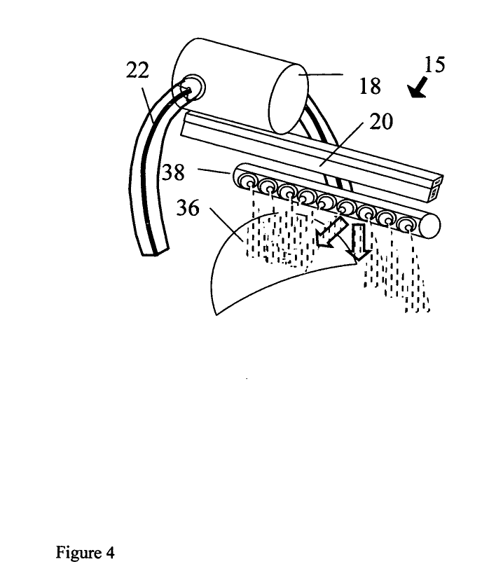

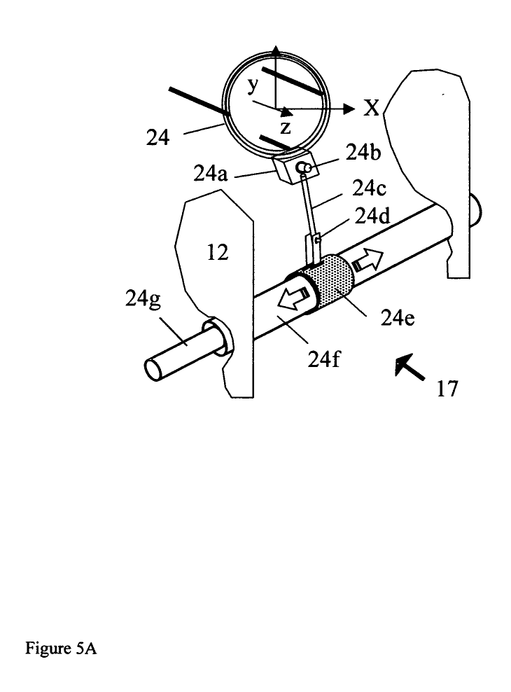

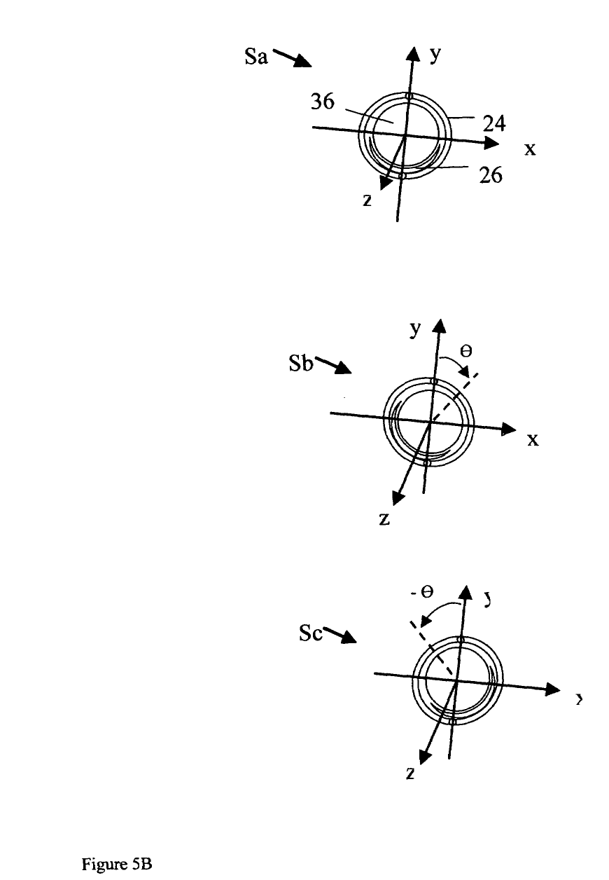

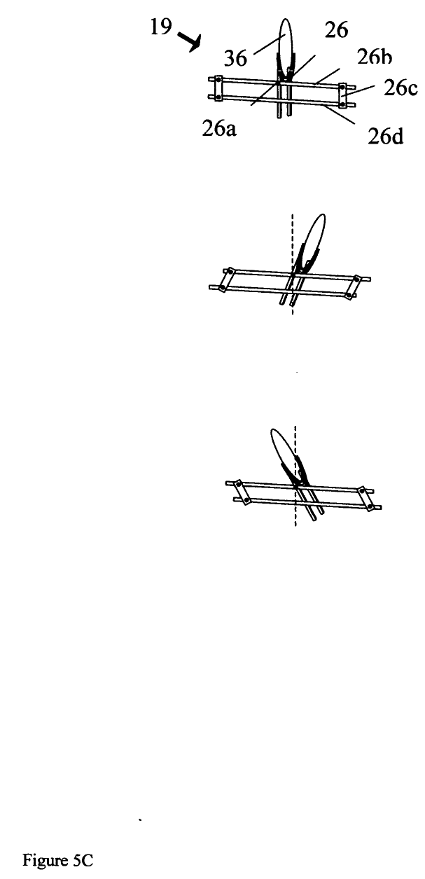

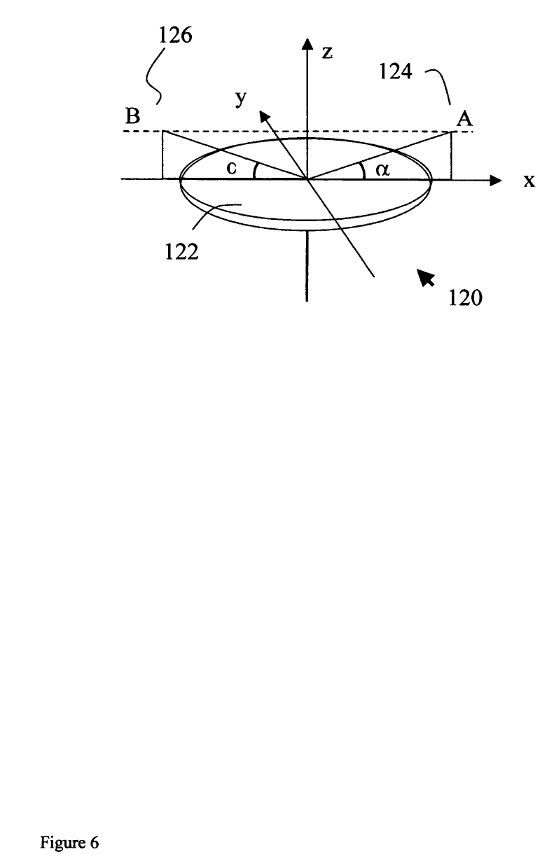

FIGS. 3 and 4 are blown up sections of FIG. 1 and show how the nozzles 38 spray the drying agent to the surface of the object 36. The nozzles 38 are preferably positioned to help the solvent replacement process by delivering the drying agent to the surface of the solid objects with enough force to cause mixing of the drying agent and the existing adsorbed solvent (water for example) but not enough to damage the objects. In addition, the nozzles are designed such that their output impinges directly on the surface of the wafers. To this end, the nozzles are distributed along the perimeter of the wafer. FIG. 6 shows a more detailed view 120 of relationship between the wafer 122 and two nozzles 124 and 126. A coordinate system is defined such that the x and y axes are in the plane of the wafer. If the wafer is held vertically, for example, the x-axis is defined to be horizontal and the y-axis is vertical. In this coordinate system the z-axis is perpendicular to the wafer surface. The nozzles are preferably distributed around the x-axis. For example there may be plurality of wafers distributed between +60 to −60 degrees from the x-axis. Similarly, there will be a distribution of nozzles along the −x axis. In some embodiments, as in FIG. 5, the nozzles may be positioned above the x-y plane, but it is oriented such that the output of the nozzles impinges upon the wafer surface.

FIGS. 5A, 5B, and 5C show three exemplary swaying mechanisms. The swaying mechanism 17 shown in FIG. 5A is used to tilt the launch boat 24, and the embedded cassette holder (not shown), in the xy plane. The sliding sleeve 24e, which is made of a magnetic material such as ferrite for example, is moved in the direction of the two arrows (−x and +x directions) by a magnetic bar 24g which resides and is movable within a sleeve 24f. The sleeve 24f is sealed on the two walls of the chamber 12. The yoke 24d, the moving lever arm 24c and the shaft 24b (z-direction) transfer the motion of 24e to the launch boat. This is an example of a swaying motion that can be induced and controlled from outside the chamber eliminating the need to put added components inside the chamber 12. FIG. 5B is another swaying mechanism that does not move the launch boat 24 rather it rotates the cassette holder 26, and therefore the object 36, in the xy plane. Sa shows the initial position of the cassette holder, Sb shows how the cassette holder has rotated by an angle θ away from the y axis, and Sc shows the motion to the opposite side at an angle −θ, Similarly, the swaying mechanism 10 shown in FIG. 5C sways the cassette holder 26 and the object 36 around the z axis. The movable shaft 26b is coupled to the cassette holder 26 with a swivel 26a. The movable shaft 26b can be laterally moved relative to a fixed shaft causing the cassette holder to swivel about the z axis as shown in FIG. 5C.

While the nozzles spray the surface(s), it is possible to sway the wafer(s). One sway motion changes the wafer orientation from vertical to an angle β relative to vertical axis and back to vertical. The swaying mechanism may also change the wafer angle from zero to β, back to zero, continuing to −β, and back to zero for a complete cycle. The sway angles on the two sides of zero (vertical) may be different. The swaying moves the wafer surface relative to nozzles causing varying aerial coverage relative to a fixed nozzle, redistributes the spray mechanical energy, and changes the effect of gravitational force on the droplets at least temporarily. These effects provide more time for the mixing of drying agent and the adsorbed water. In another embodiment of the invention, the swaying mechanism may be part of the nozzle section and it moves the orientation of the nozzles. The two swaying mechanisms may work individually or at the same time. Another, simpler swaying motion may move the cassette in a lateral motion along the z direction and back. Yet another swaying motion may rotate the cassette around the z axis.

The mechanical energy transfer from the drying agents, jetting out of the nozzles, to the surface of the wafer helps mix the adsorbed water (or other solvent) with the drying agent for easier removal. In addition, if the wafer is held vertical, the force of gravity will help move any droplets that may form by this mixing, to the bottom of the object which then either drop or be blown away by the gas flow. The droplets will be made of a mixture of the water, the impurities (if any), and the drying agent.

Operationally, the method of drying the solid objects 36 starts with the solid objects being rinsed in a rinsing unit prior to introduction to the dryer 10. The rinsing is preferably done using de-ionized water. This rinsing step removes most of the ionic solutions and the particulates that are the by-products of manufacturing process. At the end of rinsing step there are patches of thin water film on the surface of the solid objects 36, in addition there may be larger droplets of water adhering to the surface. It is well known in the art that this water contains minute amounts of salts and particulates, that when dried, deposit what is called water spots (water marks) on the surface and interfere with the proper operation of the next manufacturing step. Thus, if further cleaning needed, the first step is to provide a drying agent such as ethanol, isopropyl alcohol, or water vapor to remove most, if not all, of the surface water and the impurities contained in, and replace it with one these drying agents (this step cleans the solid objects). In this method a liquid solvent is selected from the tanks 54, 56, or 58 and is transferred to the nozzles 38 which in turn spray the surface of the objects. Excess drying agent and some of the adsorbed water turn into droplets that are forced by gravity to fail to the bottom of the chamber and removed through port 34.

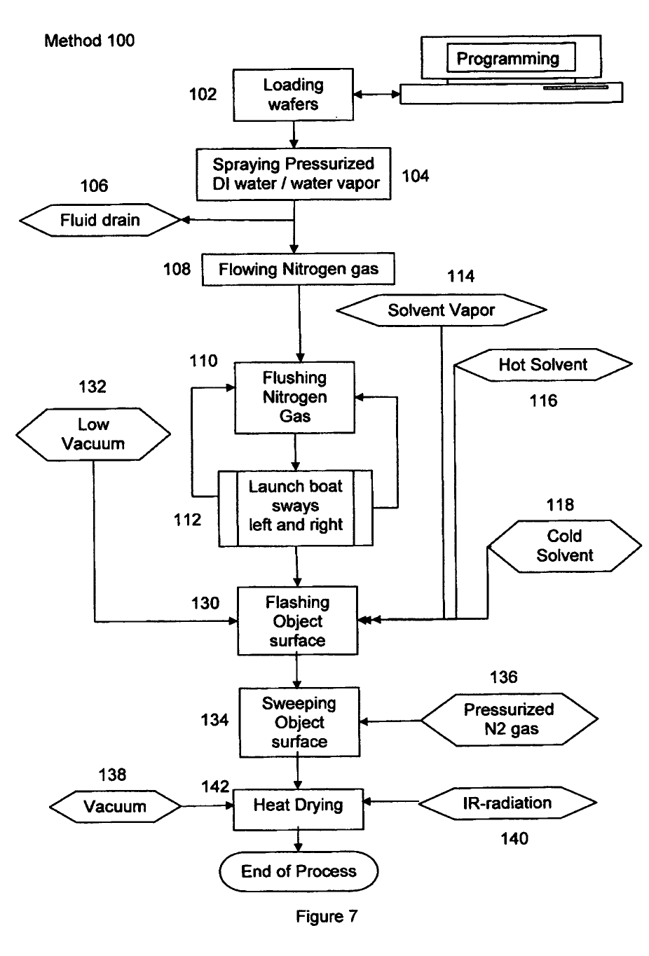

One method 100 of drying the solid objects 36 is summarized in FIG. 7. In step 102 the solid objects 36 are loaded in a cartridge or cassette boat 26 and inserted into the dryer 10. In step 104, a supply of pressurized DI-water or pressurized water vapor, is sprayed on the solid objects 36 through nozzles 38 to remove the water droplets and some of the water films from the surfaces and possibly from the cartridge. The solid objects 36 may be swayed to facilitate the delivery of drying agent to, and removal of water from their surface. The fluid droplets are drained from the chamber in step 106. Next, in step 108, partial drying step, a stream of nitrogen gas is sprayed on the surface of the objects 36 to assist in flushing 110 while swaying 112 the objects or the nozzles. Steps 110 and 112 may be repeated as required. This step is adjusted to avoid complete drying since some water still exists on the surface and drying it at this stage would lead to water spots. Next there is either a spray of solvent vapor 114, or a hot solvent liquid 116, or a cold solvent 118 on the surface of the solid objects followed by flashing 130 the surface object with nitrogen. At this stage the vacuum pump may be used to create slight vacuum 132 to assist in the flow of drying agents. In the sweeping step 134, pressurized nitrogen gas 136 is used to remove as much of the drying agent and any left over water from the surface as possible. Finally, in step 142, the vacuum 138 provided by pump 40, removes all organic vapor from chamber 10; this is followed with heating and drying the objects using IR-radiation 140.

The method 100 shown in FIG. 7 relies on applying drying agents in the form of liquids or fog. While the drying agent is applied, the solid objects 36 may be swayed to facilitate exposure of their surface to the incoming drying agent. The fog coalesces on the surfaces of the solid objects 36, combines with the water film, and form droplets that fall down and collect at the bottom of chamber 12. Subsequent coalescence of the fog on the surface help further remove the water from the surface so that at the end, only a thin film of liquid drying agents is present on the surface of the solid objects. At this point the collected liquid at the bottom of the chamber is removed through drain 34 and the extra fog is pumped out of the chamber using vacuum.

In the heat-drying step 142 the IR lamps are turned on. The step of using IR to heat-dry the solid objects works on three fronts. First, the IR radiation is absorbed by different gaseous components present in the process chamber such as water vapor, vapor pressure of the drying agent chemicals, etc leading to hot gases that transfer their energy to other gas components such as nitrogen. The hot gases flow in the space between the solid objects and cause both the front and back surfaces to dry out. Secondly, the IR radiation is known to pass through Silicon wafers in the wavelength range 1330-1550 nm. Since the light source is broadband it contains short, medium, and long wavelength and a portion of the optical energy will be able to pass through layers of Silicon and heat-dry both sides of the individual wafers. This mechanism works in tandem with the first mechanism above. In addition, in a third mechanism, the IR is used to heat ceramic that is in contact with the tubes that carry the gas or vapors or liquid (not shown), to the process chamber 12. The ceramic material adsorbs the IR radiation, heats up, and transfers the thermal energy to the flowing gas, vapor or liquid.

Once the drying process is complete, the cartridge containing solid objects is removed from dryer 10 and used in the subsequent manufacturing step. At this point in time, the temperature of the solid objects is above the ambient temperature. As long as the temperature of solid objects remains above the ambient, the chance of condensation on their surface is minimized.

Preliminary experimentation with a prototype of this invention showed wafers could be dried in less than 5 minutes. In these experiments 25 wafers were used in a batch and all dried within 5 minutes.

The method of the invention as described in FIG. 7 contains several distinct steps. The order of these steps may be changed and some of these steps may be totally removed from the flow diagram without departing from the spirit of this invention. In addition, some of the steps in the method may have to be repeated until the desired objective is achieved. Likewise the apparatus of FIG. 1 is exemplary and is composed of components some of which may not be needed in some circumstances. If that is the case, those components may be removed from the assembly without departing from the spirit of this invention.

While the foregoing detailed description has described several embodiments of the apparatus and method of drying solid objects in accordance with this invention, it is to be understood that the above description is illustrative only and not limiting of the disclosed invention. Particularly, while semi-conductor wafers may have been discussed as the primary articles to be dried, the apparatus and method herein are not so limited. As noted above, the apparatus and method herein are primarily designed for solid objects. Additionally, while specific dimensions and mixtures have been disclosed, the invention herein is not so limited. It will be appreciated that the embodiments discussed above and the virtually infinite embodiments that are not described in detail are easily within the scope and spirit of this invention. Thus, the invention is to be limited only by the claims as set forth below.

What is claimed is:

1. An apparatus for drying an object having a solvent on its surface comprising:
a) a chamber containing one or more objects in a cartridge, the cartridge being capable of swaying the objects;
b) one or more nozzle sections comprising a plurality of nozzles, attached to the chamber and capable of delivering a drying agent;
c) an optical radiation heating source attached to the inside of the chamber; and
d) a vacuum section connected to the chamber.

2. The apparatus of claim 1 wherein the chamber is made of non-corroding material.

3. The apparatus of claim 1 wherein cartridge is coated with PTFE, HDPP, or HDPE.

4. The apparatus of claim 1 wherein the output of the plurality of nozzles is directed towards the face of the objects.

5. The apparatus of claim 1 wherein one or more nozzle sections are distributed around the circumference of an object.

6. The apparatus of claim 1 wherein nozzles are distributed in the plane, above the plane, or below the plane of the object.

7. The apparatus of claim 1 wherein the optical radiation-heating source comprises a visible radiation source.

8. The apparatus of claim 1 wherein the optical radiation-heating source comprises an infra-red radiation source.

9. The apparatus of claim 1 wherein the optical radiation-heating source is a microwave source.

10. The apparatus of claim 1 wherein the drying agent is a gas, a liquid, or a mixture of a gas and a liquid.

11. The apparatus of claim 1 wherein the swaying mechanism changes the orientation of the objects relative to vertical direction.

12. The apparatus of claim 1 wherein the one or more nozzle sections are capable of swaying the orientation of nozzles.

13. The apparatus of claim 1 further comprising a pre-vacuum tank.

14. An method of drying an object having a solvent on its surface, comprising:
a) placing one or more objects in a cartridge, the cartridge being capable of swaying the objects;
b) placing the cartridge in a chamber, the chamber further comprising one or more nozzle sections comprising a plurality of nozzles, an optical radiation heating source, and a vacuum section;
c) spraying the objects with a drying agent while swaying the objects;
d) removing the drying agent and solvent from the chamber using the vacuum section; and
e) heating the objects using the optical radiation-heating source, while using the vacuum section.

15. The method of claim 14 wherein the drying agent is a gas, a liquid, or a mixture of a gas and a liquid.

16. The method of claim 14 wherein the drying agent is one or more members of a group consisting of nitrogen gas, inert gases, air, methyl alcohol, ethyl alcohol, propyl alcohol, and isopropyl alcohol.

17. The method of claim 14 wherein the one or more nozzle sections are capable of swaying the orientation of nozzles and spraying impinges the drying agent on a surface of the objects.

18. The method of claim 14 wherein the spraying step and the removing step are repeated.

19. An apparatus for drying an object having a solvent on its surface comprising:
a) a chamber containing one or more objects in a cartridge;
b) one or more nozzle sections comprising a plurality of nozzles, attached to the chamber and capable of delivering a drying agent;
c) an optical radiation heating source attached to inside of the chamber; and
d) a vacuum section connected to the chamber.

20. An method of drying an object having a solvent on its surface, comprising:
a) placing one or more objects in a cartridge and placing the cartridge in a chamber, the chamber containing one or more nozzle sections comprising a plurality of nozzles, an optical radiation heating source attached to inside of the chamber, and a vacuum section connected to the chamber;
b) spraying the objects with a drying agent;
c) removing the drying agent and solvent from the chamber using the vacuum section; and
d) heating the objects using the optical radiation heating source, while using the vacuum section.
